(19) United States
(12) Patent Application Publication
(10) Pub. No.: US 2026/0296428 A1
(43) Pub. Date: Oct. 1, 2026

(54) APPARATUS AND METHOD FOR CONTROLLING VEHICLE STUCK ESCAPE AND VEHICLE AND STORAGE MEDIUM INCLUDING THE SAME

(71) Applicants: Hyundai Motor Company, Seoul (KR); Kia Corporation, Seoul (KR); HL Mando Corporation, Pyeongtaek-si (KR)

(72) Inventors: Woon Ki CHO, Hwaseong-si (KR); Jin Young LEE, Hwaseong-si (KR); Jun Han KANG, Hwaseong-si (KR); Young Il KIM, Hwaseong-si (KR); Seung Hyeok BAEK, Hwaseong-si (KR); Soon Ju KIM, Hwaseong-si (KR); Ji Hyeon LEE, Hwaseong-si (KR); Seung Woo JO, Suwon-si (KR); Byoung Jin PARK, Seongnam-si (KR)

(73) Assignees: Hyundai Motor Company, Seoul (KR); Kia Corporation, Seoul (KR); HL Mando Corporation, Pyeongtaek-si (KR)

(21) Appl. No.: 19/344,729

(22) Filed: Sep. 30, 2025

(30) Foreign Application Priority Data
Mar. 27, 2025 (KR) 10-2025-0039446

(51) Int. Cl. B60W 30/18; B60W 10/08; B60W 30/02; B60W 50/14

(52) U.S. Cl. CPC B60W 30/18045; B60W 10/08; B60W 30/02; B60W 50/14; B60W 2510/1005; B60W 2520/06; B60W 2520/10; B60W 2520/105; B60W 2520/26; B60W 2520/28; B60W 2520/30; B60W 2540/10; B60W 2710/083; B60W 2720/24

(57) ABSTRACT

An apparatus for controlling vehicle stuck escape includes a controller configured to store a swing control logic configured to control swing motion of a vehicle for the vehicle to escape from a stuck state thereof and control the swing motion of the vehicle according to the swing control logic, wherein the swing control logic is configured so that a slope characteristic of one cycle of a forward torque pattern which is in a forward direction with respect to the swing motion of the vehicle and a slope characteristic of one cycle of a reverse torque pattern which is in a reverse direction with respect to the swing motion of the vehicle are different from each other.

### CROSS-REFERENCE TO RELATED APPLICATION(S)

The present application claims benefit of priority to Korean Patent Application No. 10-2025-0039446 filed on Mar. 27, 2025, the present disclosure of which is incorporated herein by reference in its entirety.

### BACKGROUND

### 1. Field

The present disclosure relates to an apparatus and method for controlling vehicle stuck escape and a vehicle and storage medium including the same.

### 2. Description of Related Art

The number of people who enjoy camping using vehicles and the number of people who enjoy off-road driving sports have continuously increased. Accordingly, a technology allowing comfortable and safe driving on unpaved off-road terrains other than general paved roads has been required, and thus, various vehicle driving control modes helping to control the driving of vehicles specialized for off-road applications have been developed.

When driving off-road, it is important to drive so that vehicles do not get stuck. Here, a stuck vehicle refers to a vehicle in a state in which the vehicle is stuck in the road surface and cannot move. If a vehicle gets stuck, not only will the vehicle not be able to move, but it may also be very difficult to move the vehicle that has been stuck once again. In particular, in the case of inexperienced drivers, as they try to control the vehicle more strongly to escape from being stuck, the vehicle may become more stuck, and the stuck vehicle may eventually be freed from the stuck state only by use of external force, such as that of a tow truck.

### BRIEF SUMMARY

Various aspects of the present disclosure are to provide an apparatus and method for controlling vehicle stuck escape and a vehicle and storage medium including the same, configured for effectively improving escape performance from a stuck situation (e.g., an escape success rate compared to escape difficulty) according to swing motion control.

According to various aspects of the present disclosure, an apparatus for controlling vehicle stuck escape includes: a controller configured to store a swing control logic configured to control swing motion of a vehicle for the vehicle to escape from a stuck state thereof and control the swing motion of the vehicle according to the swing control logic, wherein the swing control logic is configured so that a slope characteristic of one cycle of a forward torque pattern which is in a forward direction with respect to the swing motion of the vehicle and a slope characteristic of one cycle of a reverse torque pattern which is in a reverse direction with respect to the swing motion of the vehicle are different from each other.

According to various aspects of the present disclosure, the swing control logic may be configured so that at least one of a maximum slope, an initial slope, or an average slope of one cycle of the reverse torque pattern is steeper than at least one of a maximum slope, an initial slope, or an average slope of one cycle of the forward torque pattern.

According to various aspects of the present disclosure, the swing control logic may be configured so that a slope change rate of one cycle of the reverse torque pattern is higher than a slope change rate of one cycle of the forward torque pattern.

According to various aspects of the present disclosure, the swing control logic may be configured to determine a road surface condition based on monitoring data received from a sensor unit of the vehicle and to vary the slope characteristic of at least one of the reverse torque pattern and the forward torque pattern according to the road surface condition.

According to various aspects of the present disclosure, the swing control logic may be configured to determine whether the vehicle escapes from a stuck state based on the monitoring data for each cycle of the swing motion and to selectively vary the slope characteristic of the reverse torque pattern according to a result of the determining of whether the vehicle escapes, and the monitoring data of the sensor unit includes longitudinal acceleration of the vehicle.

According to various aspects of the present disclosure, the swing control logic may be configured to determine a swing control characteristic based on monitoring data of a sensor unit of the vehicle for each cycle of the swing motion, and the swing control characteristic includes at least one of a swing displacement of one cycle and a swing time of one cycle, and the monitoring data may include at least one of speed, wheel speed, longitudinal acceleration, wheel torque, an acceleration input value, or a gear input value of the vehicle.

According to various aspects of the present disclosure, the swing control logic may be configured to determine whether the vehicle is configured to escape from being stuck by the swing motion based on monitoring data received from a sensor unit of the vehicle and to selectively output an escape impossibility alarm signal based on a determination.

According to various aspects of the present disclosure, the controller may further store a stability control logic configured to control driving stability of the vehicle, the swing control logic may be configured to determine a wheel slip rate of the vehicle based on monitoring data received from a sensor unit of the vehicle for each cycle of the swing motion and to selectively determine whether to lock the stability control logic depending on whether at least one of a difference in wheel slip rates of a plurality of wheels, a maximum wheel slip rate of the plurality of wheels, or an average of the wheel slip rates of the plurality of wheels exceeds a reference value, and the monitoring data may include at least one of speed, wheel speed, longitudinal acceleration, wheel torque, an acceleration input value, or a gear input value of the vehicle.

According to various aspects of the present disclosure, the controller may be configured to determine whether the vehicle enters a stuck state while driving based on monitoring data received from a sensor unit of the vehicle and selectively is configured to control swing motion of the vehicle based on the swing control logic according to a result of determining whether the vehicle enters a stuck state, and the monitoring data may include at least one of speed, wheel speed, longitudinal acceleration, wheel torque, an acceleration input value, or a gear input value of the vehicle.

According to various aspects of the present disclosure, the swing control logic may be configured to determine a real-time driving direction of the controller based on monitoring data of a sensor unit of the vehicle, select one of the forward torque pattern and the reverse torque pattern according to the determined real-time driving direction, and apply the selected torque pattern to real-time driving of the controller, and the monitoring data may include at least one of speed, wheel speed, longitudinal acceleration, wheel torque, an acceleration input value, or a gear input value of the vehicle.

According to various aspects of the present disclosure, a method for controlling vehicle stuck escape includes: storing a swing control logic configured to control swing motion of a vehicle for the vehicle to escape from a stuck state; and controlling the swing motion of the vehicle according to the swing control logic, wherein the swing control logic may be configured so that a slope characteristic of one cycle of a forward torque pattern which is in a forward direction with respect to the swing motion of the vehicle and a slope characteristic of one cycle of a reverse torque pattern which is in a reverse direction with respect to the swing motion of the vehicle are different from each other.

According to various aspects of the present disclosure, the swing control logic may be configured so that at least one of a maximum slope, an initial slope, or an average slope of one cycle of the reverse torque pattern is steeper than at least one of a maximum slope, an initial slope, or an average slope of one cycle of the forward torque pattern.

According to various aspects of the present disclosure, the swing control logic may be configured to determine a road surface condition based on monitoring data received from a sensor unit of the vehicle and to vary the slope characteristic of at least one of the reverse torque pattern and the forward torque pattern according to the road surface condition.

According to various aspects of the present disclosure, the swing control logic may be configured to determine a swing control characteristic based on the monitoring data of the sensor unit of the vehicle for each cycle of the swing motion, the swing control characteristic may include at least one of a swing displacement of one cycle and a swing time of one cycle, and the monitoring data may include at least one of speed, wheel speed, longitudinal acceleration, wheel torque, an acceleration input value, or a gear input value of the vehicle.

According to various aspects of the present disclosure, there is provided a storage medium having recorded thereon one or more programs including instructions for executing a method for controlling vehicle stuck escape.

According to various aspects of the present disclosure, a vehicle includes: a controller including a processor and a storage medium having recorded thereon one or more programs configured to be executable by the processor, wherein the one or more programs include instructions for executing the method for controlling vehicle stuck escape.

According to various aspects of the present disclosure, a vehicle includes: a first motor providing torque to a front wheel; a second motor providing torque to a rear wheel; and a controller storing a swing control logic configured to control swing motion of a vehicle for the vehicle to escape from a stuck state thereof and controlling the first motor and the second motor according to the swing control logic, wherein the swing control logic may be configured so that a slope characteristic of one cycle of a forward torque pattern which is in a forward direction with respect to the swing motion of the vehicle and a slope characteristic of one cycle of a reverse torque pattern which is in a reverse direction with respect to the swing motion of the vehicle are different from each other.

According to various aspects of the present disclosure, the vehicle may further include: a sensor unit sensing monitoring data including at least one of speed, wheel speed, longitudinal acceleration, wheel torque, an acceleration input value, or a gear input value of the vehicle, wherein the swing control logic is configured to determine torque directions of the first motor and the second motor based on the monitoring data and selects one of the forward torque pattern and the reverse torque pattern according to the determined real-time torque direction, and the controller is configured to control the first motor and the second motor according to the selected torque pattern.

According to various aspects of the present disclosure, the swing control logic may be configured so that at least one of a maximum slope, an initial slope, or an average slope of one cycle of the reverse torque pattern is steeper than at least one of a maximum slope, an initial slope, or an average slope of one cycle of the forward torque pattern.

According to various aspects of the present disclosure, the swing control logic may be configured to determine a road surface condition based on the monitoring data and to vary the slope characteristic of at least one of the reverse torque pattern and the forward torque pattern according to the road surface condition, and the monitoring data of the sensor unit may include longitudinal acceleration of the vehicle.

### BRIEF DESCRIPTION OF DRAWINGS

Various aspects, features, and advantages of the present disclosure will be more clearly understood from the following detailed description,

FIG. 1 and FIG. 2 are diagrams illustrating an apparatus for controlling vehicle stuck escape and a vehicle according to an exemplary embodiment of the present disclosure;

FIG. 3 is a block diagram illustrating a controller and a sensor unit of an apparatus and method for controlling vehicle stuck escape and a vehicle and a storage medium according to an exemplary embodiment of the present disclosure;

FIG. 4 and FIG. 5 are diagrams illustrating forward and reverse driving of swing motion control of an apparatus and method for controlling vehicle stuck escape and a vehicle and a storage medium according to an exemplary embodiment of the present disclosure;

FIG. 6 is a graph illustrating a forward torque pattern and a reverse torque pattern of the swing motion control of FIG. 4 and FIG. 5;

FIG. 7 is a flowchart illustrating a method for controlling vehicle stuck escape according to an exemplary embodiment of the present disclosure;

FIG. 8 is a flowchart illustrating swing motion control of an apparatus and method for controlling vehicle stuck escape and a vehicle and a storage medium according to an exemplary embodiment of the present disclosure;

FIG. 9 is a flowchart illustrating swing motion control of an apparatus and method for controlling vehicle stuck escape and a vehicle and a storage medium according to an exemplary embodiment of the present disclosure; and

FIG. 10 is a diagram illustrating monitoring data of a sensor unit in a swing motion control process of an apparatus and method for controlling vehicle stuck escape and a vehicle and a storage medium according to an exemplary embodiment of the present disclosure.

### DETAILED DESCRIPTION

While the present disclosure may be modified in various ways and take on various alternative forms, specific embodiments thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc., may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms used herein to describe embodiments of the present disclosure is not intended to limit the scope of the present disclosure. The articles “a,” and “an” are singular in that they have a single referent, however the use of the singular form in the present specification should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to include the same meanings as those of the contexts of the related art, and unless clearly defined in the application, they should not be construed to have ideally or excessively formal meanings.

In the present specification, vehicles refer to a variety of vehicles that move transported objects, such as people, animals, or goods, from a starting point to a destination. These vehicles are not limited to vehicles that run on roads or tracks.

Hereinafter, various exemplary embodiments of the present disclosure will be described with reference to the accompanying drawings.

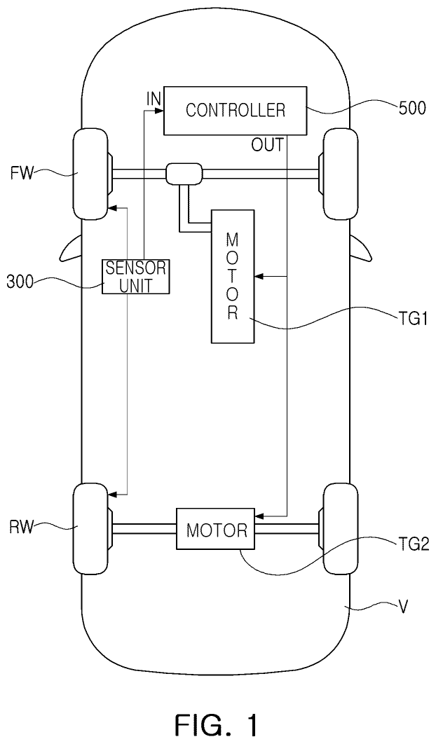

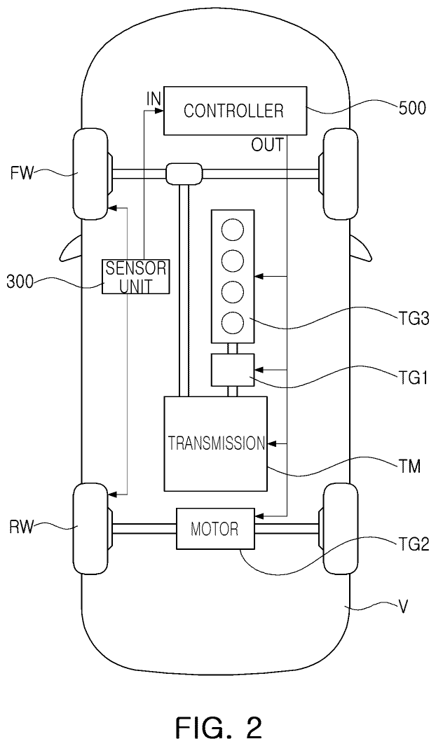

Referring to FIG. 1 and FIG. 2, a vehicle V may include a first motor TG1 providing torque to a front wheel FW and a second motor TG2 providing torque to a rear wheel RW of the vehicle V. The vehicle V may be configured for all-wheel drive (AWD), while being controlled as 4 wheel drive (4WD). AWD may be a driving method that may freely determine the torque of the front wheel FW and the torque of the rear wheel RW, and may be a driving method that may flexibly determine a torque distribution ratio of the front wheel FW and the rear wheel RW.

Referring to FIG. 1, the vehicle V may include an electric vehicle not including an engine. Referring to FIG. 2, the vehicle V may include a hybrid electric vehicle (including a plug-in hybrid electric vehicle) including an engine TG3 and a transmission TM. The configuration (e.g., number, position, connection relationship, etc.) of the first and second motors TG1 and TG2 is not limited. For example, at least one of the first and second motors TG1 and TG2 may include a converter (e.g., an inverter) for converting between direct current and alternating current and may include a battery (e.g., a high-voltage battery pack) storing energy and being rechargeable.

Referring to FIGS. 1, 2, and 3, the vehicle V according to an exemplary embodiment of the present disclosure may include a sensor unit 300 and a controller 500. For example, the controller 500 may include a vehicle control unit (VCU) and/or a microcontroller unit (MCU).

The sensor unit 300 may include at least one of the vehicle speed sensor 302, the acceleration sensor 305, the wheel speed sensor 303, the torque sensor 306, the APS sensor 308, and a gear input sensor 309.

The sensor unit 300 may sense (e.g., constantly sense) monitoring data of the vehicle V. For example, the monitoring data may include at least one of a speed of the vehicle V (a sensing value of a vehicle speed sensor 302 of the sensor unit 300), an acceleration of the vehicle V (a sensing value of an acceleration sensor 305 of the sensor unit 300), revolutions per minute (rpm) of the wheels (the front wheel FW and/or the rear wheel RW) of the vehicle V (a sensing value of a wheel speed sensor 303 of the sensor unit 300), a torque of the vehicle V (a sensing value of a torque sensor 306 of the sensor unit 300), and an acceleration input value of the vehicle V (a sensing value of an APS sensor 308 of the sensor unit 300). The torque of the vehicle V may include the torque of the engine (or motor) and/or the torque of the wheels (front wheels FW and/or rear wheels RW). The acceleration of the vehicle V may include the longitudinal acceleration of the vehicle V and/or the lateral acceleration of the vehicle V. The APS of the APS sensor 308 may be an accelerator pedal sensor.

The controller 500 operatively connected to the sensor unit 300 may receive the monitoring data from the sensor unit 300 and control the torque of the first and second motors TG1 and TG2 based on the monitoring data. For example, by controlling the AWD, the controller 500 may be configured for controlling a front and rear wheel torque distribution ratio by determining the torque distribution ratio of the first and second motors TG1 and TG2. The controller 500 may change the front and rear wheel torque distribution ratio (which may be accompanied by a change in the total torque) by reducing or increasing the torque of one of the first and second motors TG1 and TG2 and may also change the front and rear wheel torque distribution ratio while maintaining the total torque by complementarily changing the torque of the first and second motors TG1 and TG2.

For example, to control the AWD, the controller 500 may store in advance a vehicle stability control logic (e.g., turning control logic, traction control system (TCS), electronic stability program (ESP), etc.) or a performance-fuel efficiency optimization control logic, may independently determine the torque of the first motor TG1 and the torque of the second motor TG2 in real time according to the vehicle stability control logic and/or the performance-fuel efficiency optimization control logic, and may flexibly control the first and second motors TG1 and TG2 according to the determined torque. Accordingly, the overall optimality of at least one of the performance, fuel efficiency, and stability of the vehicle V may be improved.

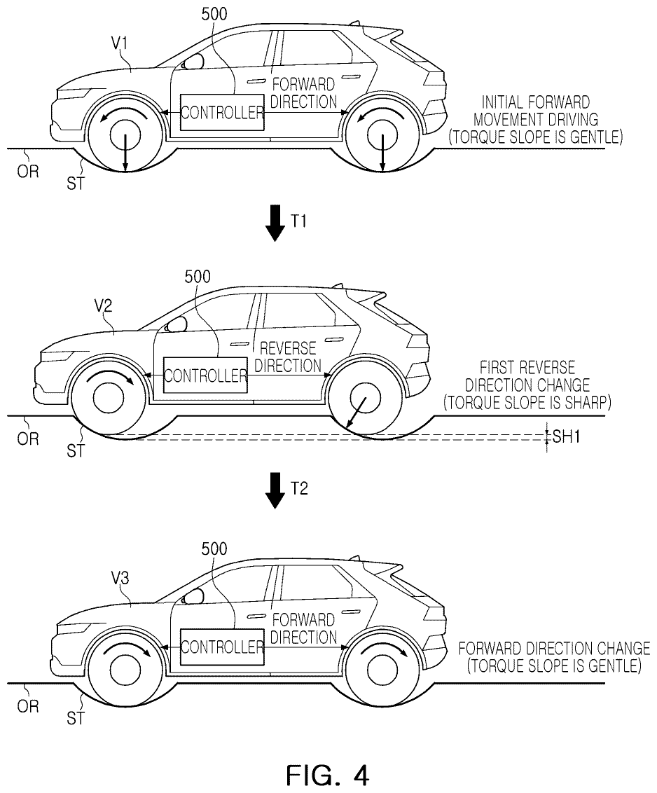

Referring to FIG. 4, the vehicle V1 may drive on a road surface OR. For example, the road surface OR may include an off-road terrain. The off-road terrain may include a non-road surface (e.g., a snowy road, a muddy road, a sandy road) and may include a road with a bad road condition. Unlike an ideal road, road surface severity of the off-road terrain may vary. As road surface severity to the road surface OR (e.g., a level deviation of the road surface and/or a change in the level deviation of the road surface according to the torque of the wheel) is higher, a possibility of a vehicle stuck state that the front wheel and/or rear wheel of the vehicle V1 may become stuck ST (e.g., a point at which a level gradient is the steepest) on the road surface OR and cannot get out is higher. After the vehicle V1 becomes stuck, the controller 500 may start swing motion control of the vehicle and turn off an acceleration input (e.g., an accelerator pedal input).

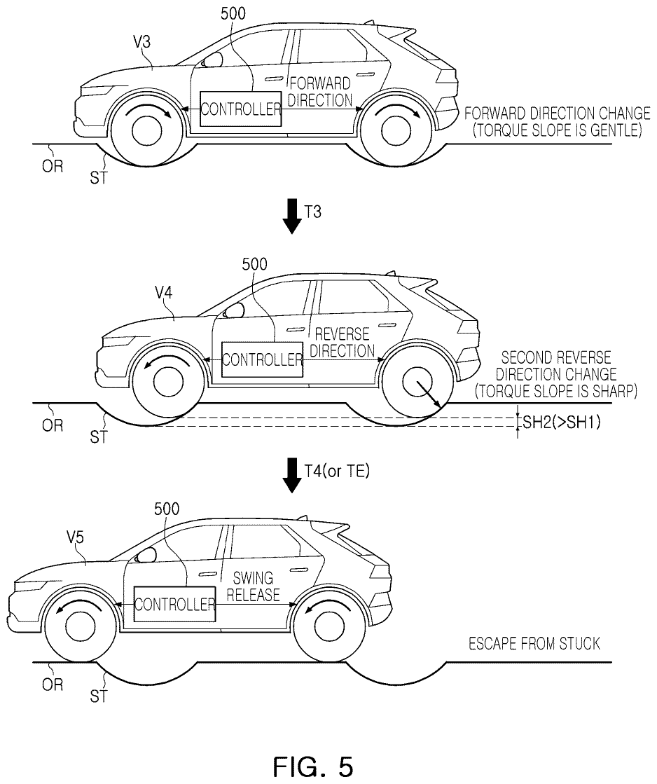

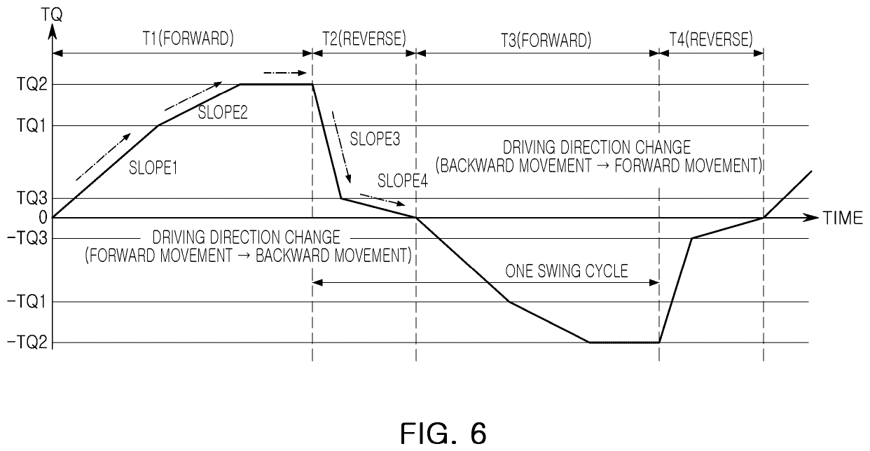

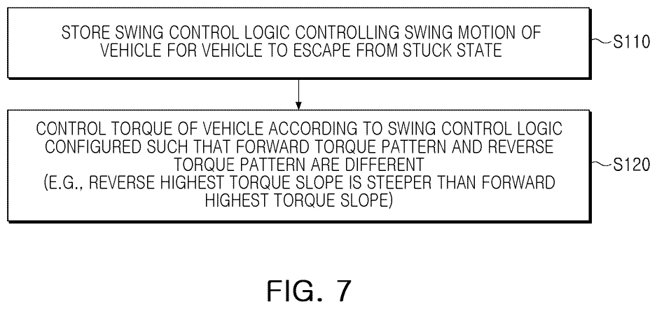

Referring to FIG. 4, FIG. 5, FIG. 6, and FIG. 7, the apparatus for controlling vehicle stuck escape and the controller 500 of the vehicle V according to an exemplary embodiment of the present disclosure may store swing control logic configured to control the swing motion of the vehicle V1, V2, V3, V4, or V5 to escape from being stuck and may be configured for controlling the swing motion of the vehicle (e.g., control of the first and second motor) according to the swing control logic. The method for controlling vehicle stuck escape according to an exemplary embodiment of the present disclosure may include an operation (S110) of storing the swing control logic configured to control the swing motion of the vehicle for the vehicle to escape from being stuck, which may be executed by the controller 500; and an operation (S120) of controlling the swing motion of the vehicle according to the swing control logic.

During first and third cycles T1 and T3, the vehicles V1 and V3 may swing back and forth away from the center portion of the stuck ST. During the first and third cycles T1 and T3, the controller 500 may be configured for controlling the first and second motors (TG1 and TG2 of FIG. 1 and FIG. 2) according to a forward torque pattern which is a forward direction (and/or a direction in which torque is applied to the front and/or rear wheels so that the vehicle moves away from the center portion of the stuck) for the back and forth swing of the vehicles V1 and V3. For example, the controller 500 may be configured to determine, in real time, torque values (e.g., TQ1, TQ2, TQ3) and a torque direction (same direction as a rotation direction of the front and/or rear wheels) provided by the first and second motors according to a predetermined forward torque pattern and may transmit a command signal corresponding to the determined torque values and torque direction to the first and second motors. Accordingly, the vehicles V2 and V4 may rise and move forward by a first displacement SH1 from the center portion of the stuck ST or rise and move backward by a second displacement SH2. Depending on the design, a chronological relationship between the forward and backward movements may vary (e.g., move backward and then forward).

During the second and fourth cycles T2 and T4, the vehicles V2 and V4 may swing back and forth to become closer to the center portion of the stuck ST. During the second and fourth cycles T2 and T4, the controller 500 may be configured for controlling the first and second motors (TG1 and TG2 of FIG. 1 and FIG. 2) according to a reverse torque pattern which is the reverse direction (and/or the direction in which torque is applied to the front and/or rear wheels so that the vehicles move away from the center portion of the stuck) with respect to the swing motion of the vehicles V2 and V4. For example, the controller 500 may be configured to determine in real time the torque values (e.g., TQ1, TQ2, TQ3) and torque direction (opposite to the rotation direction of the front and/or rear wheels) provided by the first and second motors according to a predetermined reverse torque pattern and may transmit a command signal corresponding to the determined torque values and torque direction to the first and second motors.

The number of forward torque control cycles corresponding to the first and third cycles T1 and T3 and the number of reverse torque control cycles corresponding to the second and fourth cycles T2 and T4 are not limited but may vary depending on the road surface condition of the road surface OR, the size of the stuck ST, or the design of the vehicle (and/or motor). As the order of the reverse torque control cycles is later, the displacement (e.g., SH1, SH2) of the swing motion may gradually become longer (e.g., the swing amplitude may gradually increase). When the displacement of the swing motion becomes greater than or equal to the height of the stuck ST, the vehicle V5 may escape from being stuck ST. At the instant time, the controller 500 may release the swing motion control and release the acceleration input (e.g., the accelerator pedal input) off.

In the present manner, while the vehicle swings back and forth, the ST may be gradually crushed, so that the height of the ST may be shortened and a lateral inclination of the ST may become gentle. Accordingly, the overall driving force (dependent on an uphill inclination of the vehicle) required for the vehicle to escape from the ST may be reduced and the vehicle's escape from the ST may become easier.

Furthermore, since the vehicle may form inertia according to the back and forth swing, a low-point center of gravity of the vehicle may be lowered according to the inertia. Therefore, the vehicle may more efficiently secure the overall driving force (dependent on an axle weight of the vehicle) required to escape from the ST, and the vehicle's escape from the ST may become easier.

Referring to FIG. 6, the swing control logic may be configured so that slope characteristics (e.g., the characteristics of slope 1 and/or slope 2) of one cycle (T1 and/or T3) of the forward torque pattern and slope characteristics (e.g., the characteristics of slope 3 and/or slope 4) of one cycle (T2 and/or T4) of the reverse torque pattern are different from each other. Accordingly, the controller 500 may efficiently determine the forward torque substantially regardless of the reverse torque pattern at a time when the forward torque is required in the swing motion and may efficiently determine the reverse torque substantially regardless of the forward torque pattern at a time when the reverse torque is required in the swing motion, so that the performance of escaping from the stuck ST according to the swing motion control (e.g., an escape success rate compared to escape difficulty) may be effectively improved.

For example, the swing control logic may be configured so that at least one of a maximum slope (e.g., maximum of slope 3), an initial slope (e.g., initial stage of slope 3), or an average slope (e.g., an average of slope 3 and slope 4) of one cycle of the reverse torque pattern is steeper than at least one of a maximum slope (e.g., maximum of slope 1), an initial slope (e.g., initial stage of slope 1), or an average slope (e.g., an average of slope 1 and slope 2) of one cycle of the forward torque pattern. For example, the swing control logic may be configured so that a slope change rate (e.g., a difference between slope 3 and slope 4) of one cycle of the reverse torque pattern is higher than a slope change rate (e.g., a difference between slope 1 and slope 2) of one cycle of the forward torque pattern.

Accordingly, the forward torque pattern may be configured to be relatively gentle so that the vehicle may stably climb from the center portion of the ST (e.g., reduce the overall wheel slip during a climbing process), and the reverse torque pattern may be configured to be relatively sharp so that the vehicle may implement an instantaneous vehicle braking posture to increase an axle weight. Accordingly, the controller 500 may reduce the shock caused by the swing motion, perform a large traction control, and more effectively utilize the inertia due to the swing motion to escape from the ST.

The slope characteristics may include at least one of the maximum slope, the initial slope, the average slope, or the slope change rate. When there is a plurality of slope characteristics, the slope characteristics of the forward torque pattern and the slope characteristics between the reverse torque pattern may be compared by matching between slope characteristics of the same type (e.g., matching between maximum slopes and matching between average slopes).

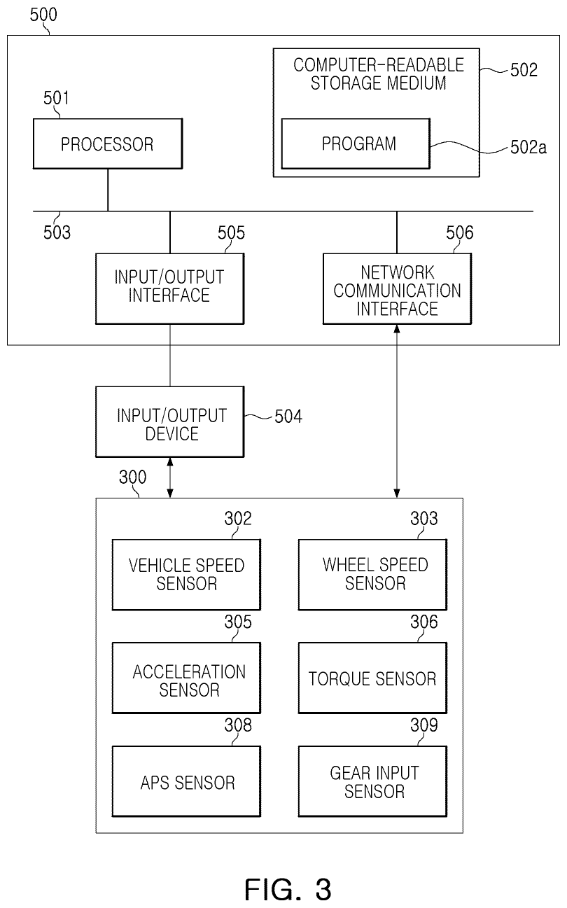

For example, the swing control logic may be configured with data (e.g., data in a lookup table format) in which a plurality of times TIME and a plurality of torques TQ correspond in a one-to-one manner, and the controller 500 may sequentially determine the plurality of torques TQ respectively for the plurality of times TIME for each swing cycle to control the first and second motors. Depending on the design, the controller 500 may be configured to determine swing control characteristics (e.g., swing displacement, swing time) and assign a weight corresponding to the swing control characteristics to the plurality of torques TQ and the plurality of times TIME. Therefore, the swing control logic does not necessarily require monitoring data of the sensor unit (300 in FIG. 3).

Alternatively, the swing control logic may be configured to determine the real-time driving direction of the controller 500 based on the monitoring data of the sensor unit (300 in FIG. 3), select one of the forward torque pattern and the reverse torque pattern according to the determined real-time driving direction, and apply the selected torque pattern to the real-time driving of the controller 500. Accordingly, the controller 500 may secure swing motion control stability based on feedback according to the monitoring data even if unexpected variables occur in swing motion control.

The swing control logic may configure the forward torque pattern and the reverse torque pattern separately. For example, the controller 500 may determine the torque direction of the first and second motors and/or select one of the forward torque pattern (when value signs are the same) and the reverse torque pattern (when the value signs are opposite to each other) according to the value sign relationship between the wheel speed sensor (303 of FIG. 3) and the torque sensor (306 of FIG. 3) of the sensor unit, and may be configured for controlling the first and second motors according to the selected torque pattern and/or the determined real-time torque direction.

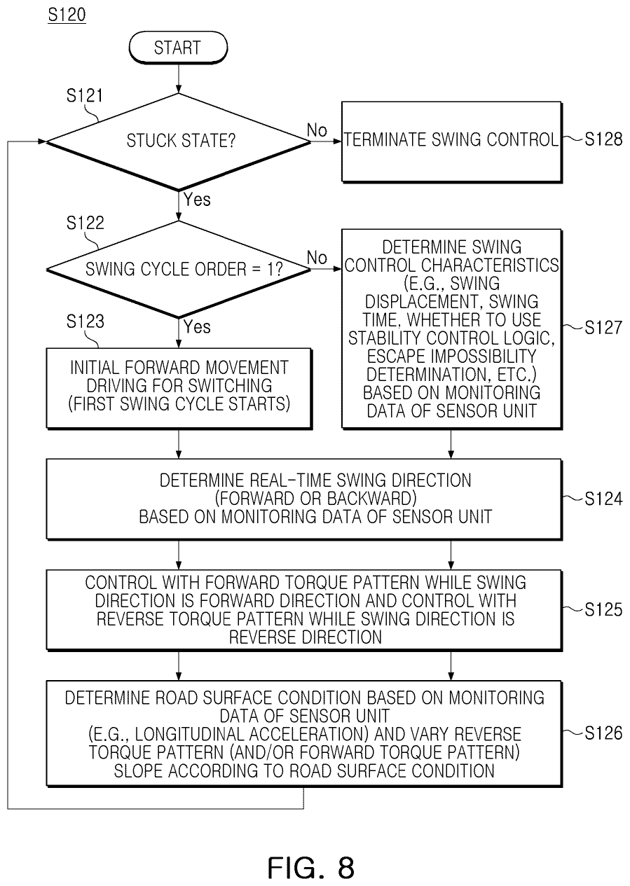

Referring to FIG. 8, in the operation (S120) of controlling the swing motion of the vehicle according to the swing control logic, the controller may be configured to determine whether the vehicle is in a stuck state (S121), terminate the swing control if the vehicle is not in a stuck state (S128), check the order of the cycle of the swing motion if the vehicle is in a stuck state (S122), and drive the initial forward movement for swing in the cycle of the first swing motion (S123). In one cycle of swing motion, the controller may be configured to determine the real-time swing direction (forward or reverse) based on the monitoring data of the sensor unit (S124), control with the forward torque pattern while the swing direction is the forward direction and control with the reverse torque pattern while the swing direction is the reverse direction (S125).

The swing control logic may be configured to determine the road surface condition based on the monitoring data of the sensor unit (e.g., longitudinal acceleration) and vary the slope characteristics of at least one of the reverse torque pattern and the forward torque pattern according to the road surface condition (S126). Accordingly, the controller may be configured for controlling the swing motion of the vehicle more adaptively to the road surface condition, so that the performance of escaping from the stuck ST according to the swing motion control (e.g., an escape success rate against escape difficulty) may be stably secured.

For example, the road surface condition may include road surface severity (e.g., a road surface level deviation and/or a change in road surface level deviation according to wheel torque) and/or road surface friction coefficient. For example, the controller may be configured to determine that the road surface severity (an example of a road surface condition) is higher as an average value of the sensing value (longitudinal acceleration) of the acceleration sensor (305 in FIG. 3) of the sensor unit during one cycle (and/or at a specific point in time) of the swing motion is lower, and as the road surface severity is higher, the controller may change the slope characteristics of the reverse torque pattern (e.g., at least one of the maximum slope, the initial slope, the average slope, or the slope change rate) to be steeper.

When the controller determines that the order of the cycle of the swing motion is not first in S122, the swing control logic may be configured to determine the swing control characteristics (S127) based on the monitoring data (e.g., longitudinal acceleration) of the sensor unit of the vehicle for each cycle of the swing motion. For example, the swing control characteristics may include at least one of a swing displacement or a swing time of one cycle.

For example, the controller may be configured to determine that the swing displacement (and/or swing time) of one cycle is longer as the sensing value (longitudinal acceleration) of the acceleration sensor (305 of FIG. 3) of the sensor unit at a predetermined point in time (a point at which the longitudinal acceleration is maximum) of the swing motion is larger. Accordingly, the controller may secure the stability of the swing motion control based on the feedback according to the real-time swing control state (corresponding to the monitoring data) and may stably secure the performance of escaping from the stuck ST (e.g., the escape success rate against the escape difficulty).

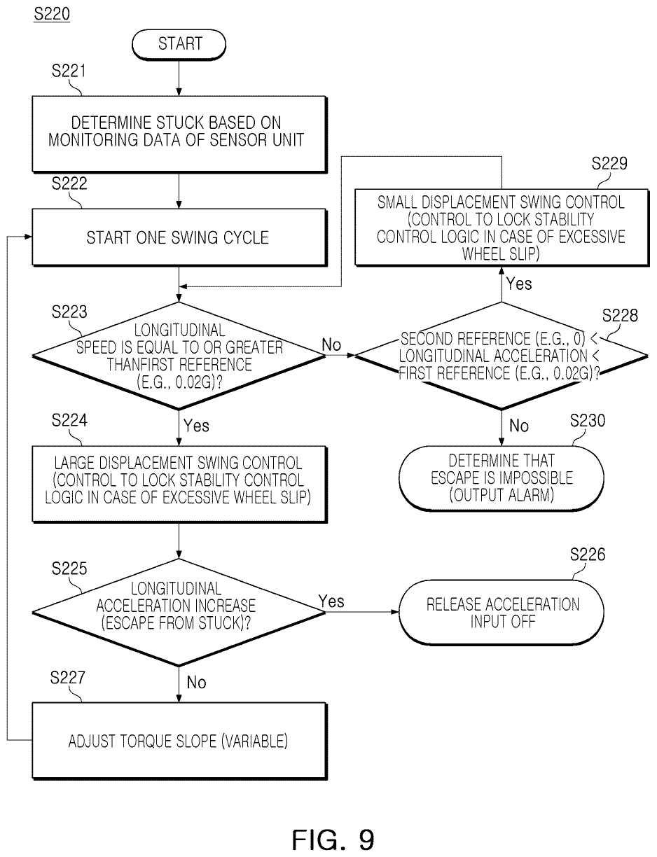

Referring to FIG. 9, in the operation (S220) of controlling the swing motion of the vehicle according to the swing control logic, the controller may be configured to determine whether the vehicle enters a stuck state while driving according to the monitoring data of the sensor unit of the vehicle (S221) and selectively control the swing motion of the vehicle according to the swing control logic according to the result of the determination of whether the vehicle enters a stuck state (S222).

In one cycle of swing motion, the controller may check (S223) whether the longitudinal acceleration (an example of monitoring data of the sensor unit) is greater than or equal to a first reference (e.g., 0.02 g), and if the longitudinal acceleration is greater than or equal to the first reference, the controller may be configured for controlling (S224) a large displacement swing (an example of swing control characteristics), and if the longitudinal acceleration is less than the first reference (the longitudinal acceleration is large), the controller may check (S228) whether the longitudinal acceleration (an example of monitoring data of the sensor unit) exceeds a second reference (e.g., 0), and if the longitudinal acceleration exceeds the second reference (the longitudinal acceleration is medium), the controller may be configured for controlling (S229) a small displacement swing (an example of the swing control characteristics). The swing control logic may be configured to determine (corresponding to S228) whether the vehicle may escape from being stuck by the swing motion based on the monitoring data (e.g., longitudinal acceleration) of the sensor unit of the vehicle and selectively output (S230) an escape impossibility alarm signal according to the determination if the swing control logic determines that the vehicle cannot escape from being stuck in S228.

The swing control logic may be configured to determine whether the vehicle escapes from a stuck state based on the monitoring data of the sensor unit of each cycle of the swing motion (S225) and to selectively vary the slope characteristic of the reverse torque pattern (S227) depending on the result of the determination of whether the vehicle escapes. For example, the controller may gradually increase the slope characteristic of the reverse torque pattern whenever the real-time longitudinal acceleration of each cycle of the swing motion does not exceed the longitudinal acceleration reference for escaping from a stuck state.

For example, the controller may be configured to determine that the vehicle escapes from a stuck state when the real-time longitudinal acceleration of one cycle of the swing motion exceeds the longitudinal acceleration reference for escaping from a stuck state (e.g., a reference higher than the first reference) for a predetermined cycle of time and may release the acceleration input off temporarily activated for the swing motion control (S226).

The controller may further store stability control logic (e.g., turning control logic, traction control system (TCS), electronic stability program (ESP), etc.) configured to control the driving stability of the vehicle. The swing control logic may be configured to determine a wheel slip rate of the vehicle based on the monitoring data of the sensor unit of the vehicle for each cycle of the swing motion and selectively determine whether to lock the stability control logic (corresponding to S224, S229) based on whether at least one of a difference in wheel slip rate of a plurality of wheels (e.g., a plurality of front wheels and a plurality of rear wheels), the maximum wheel slip rate of the plurality of wheels, or an average wheel slip rate of the plurality of wheels exceeds a reference value.

For example, the stability control logic may be configured to secure stability when the vehicle turns, so that a steep slope characteristic of the reverse torque pattern of the swing control logic may be limited. Accordingly, the controller may temporarily lock the stability control logic when the difference in wheel slip rate of the plurality of wheels is too large or the average wheel slip rate is too high during one cycle of the swing motion, improving the performance of escaping from the stuck ST (e.g., the escape success rate against the escape difficulty).

The wheel slip rate may be defined as a value obtained by dividing the difference between the RPM of the wheel (front wheel and/or rear wheel) and the speed of the vehicle by the RPM or the speed. For example, the controller may use the sensing value of the wheel speed sensor (303 in FIG. 3) of the sensor unit as the RPM and may use the sensing value of the vehicle speed sensor (302 in FIG. 3) of the sensor unit as the speed of the vehicle.

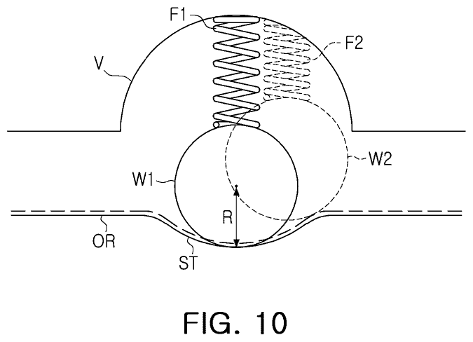

Referring to FIG. 10, a wheel W1 (e.g., the front wheel and/or the rear wheel) located at the center portion of the stuck ST may be located on a lower level than a wheel W2 located farther from the center portion of the stuck ST. Therefore, force F1 that the vehicle V presses down on the wheel W1 may be less than force F2 that the vehicle V presses down on the wheel W2, and the wheel slip rate of the wheel W1 may be higher than the wheel slip rate of the wheel W2.

For example, the swing control logic may configure the slope characteristic of the forward torque pattern to be relatively gentle, reducing the overall wheel slip of the wheel W1 in a situation in which the wheel slip rate of the wheel W1 may increase and improving the climbing stability of the wheel W1 in the stuck ST. For example, the swing control logic may configure the slope characteristic of the reverse torque pattern to be relatively sharp to thereby increase the axle weight by providing an instantaneous vehicle braking effect of the wheel W2, so that the performance of escaping from the stuck (e.g., the escape success rate against the escape difficulty) may be effectively improved according to the forward/reverse swing control. For example, the swing control logic may stably secure the escape performance by varying the slope characteristic of the forward torque pattern and/or the reverse torque pattern according to the radius R of the wheel W1 or the severity of the stuck ST.

Meanwhile, referring to FIG. 3, the controller 500 may be implemented as a computing system including at least one processor 501, a computer-readable storage medium 502, and a communication bus 503. For example, the controller 500 may be implemented as a microcontroller, an embedded system, a system on chip, etc. The storage medium 502 may record one or more programs including commands for executing a method for controlling vehicle stuck escape according to an exemplary embodiment of the present disclosure. The communication bus 503 may interconnect various other components of the determining device 500, including the processor 501 and the computer-readable storage medium 502.

The processor 501 may cause the controller 500 to operate according to the exemplary embodiments described above. For example, the processor 501 may execute one or more programs stored on the computer-readable storage medium 502. The one or more programs may include one or more computer-executable instructions, which, when executed by the processor 501, may be configured to cause the controller 500 to perform operations according to the embodiments.

The computer-readable storage medium 502 may be configured to store computer-executable instructions or program code, program data, and/or other suitable forms of information. A program 502a stored on the computer-readable storage medium 502 includes a set of instructions executable by the processor 501. In an exemplary embodiment of the present disclosure, the computer-readable storage medium 502 may be memory (volatile memory, such as random access memory, nonvolatile memory, or a suitable combination thereof), one or more magnetic disk storage devices, optical disk storage devices, flash memory devices, or any other form of storage medium that may be accessed by the controller 500 and configured for storing desired information, or a suitable combination thereof.

The controller 500 may also include one or more input/output interfaces 505 providing an interface for one or more input/output devices 504 and one or more network communication interfaces 506. The input/output interfaces 505 and the network communication interfaces 506 are connected to the communication bus 503. The network may be one of a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), 5G, Wi-Fi, or another cellular network, and may also be implemented as Ethernet, Media Oriented Systems Transport (MOST), Flexray, Controller region Network (CAN), Local Interconnect Network (LIN), Internet, Bluetooth®, Near Field Communication (NFC), Zigbee®, Radio Frequency (RF), etc.

The input/output device 504 may be connected to other components of the controller 500 via the input/output interface 505. The input/output devices 504 may include, for example, input devices, such as pointing devices (such as a mouse or trackpad), keyboards, touch input devices (such as a touchpad or a touchscreen), voice or sound input devices, various types of sensor devices and/or image capturing devices, and/or output devices, such as display devices, printers, speakers, and/or network cards. For example, the input/output devices 504 may be included inside the controller 500 as a component forming the controller 500 or may be connected to the controller 500 as a separate device distinct from the controller 500.

Meanwhile, the embodiments of the present disclosure may include a program for performing the methods described in the present specification on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording medium include magnetic medium, such as hard disks, floppy disks, and magnetic tapes, optical recording medium, such as CD-ROMs, DVDs, and hardware devices specifically configured to store and perform program instructions, such as ROM, RAM, flash memory, etc. Examples of the program may include not only machine language code, such as that generated by a compiler, but also high-level language code that may be executed by a computer using an interpreter or the like.

The apparatus and method for controlling vehicle stuck escape and the vehicle and storage medium including the same according to an exemplary embodiment of the present disclosure may effectively improve the performance of escaping from a stuck (e.g., the escape success rate against the escape difficulty) according to the swing motion control.

While embodiments have been shown and described above, it will be apparent to those skilled in the art that modifications and variations could be made without departing from the scope of the present disclosure as defined by the appended claims.

What is claimed is:

1. An apparatus for controlling vehicle stuck escape, the apparatus comprising:
a controller storing a swing control logic configured to control swing motion of a vehicle for the vehicle to escape from a stuck state thereof and controlling the swing motion of the vehicle according to the swing control logic,
wherein the swing control logic is configured so that a slope characteristic of one cycle of a forward torque pattern which is in a forward direction with respect to the swing motion of the vehicle and a slope characteristic of one cycle of a reverse torque pattern which is in a reverse direction with respect to the swing motion of the vehicle are different from each other.

2. The apparatus of claim 1, wherein the swing control logic is further configured so that at least one of a maximum slope, an initial slope, or an average slope of the one cycle of the reverse torque pattern is steeper than at least one of a maximum slope, an initial slope, or an average slope of the one cycle of the forward torque pattern.

3. The apparatus of claim 1, wherein the swing control logic is further configured so that a slope change rate of the one cycle of the reverse torque pattern is greater than a slope change rate of the one cycle of the forward torque pattern.

4. The apparatus of claim 1, wherein the controller determines a road surface condition based on monitoring data received from a sensor unit of the vehicle and varies the slope characteristic of at least one of the reverse torque pattern or the forward torque pattern according to the road surface condition.

5. The apparatus of claim 4,
wherein the controller determines whether the vehicle escapes from the stuck state based on the monitoring data for each cycle of the swing motion and selectively varies the slope characteristic of the reverse torque pattern according to a result of the determining of whether the vehicle escapes, and
wherein the monitoring data of the sensor unit includes longitudinal acceleration of the vehicle.

6. The apparatus of claim 1,
wherein the controller determines a swing control characteristic based on monitoring data of a sensor unit of the vehicle for each cycle of the swing motion,
wherein the swing control characteristic includes at least one of a swing displacement or a swing time of one cycle, and
wherein the monitoring data includes at least one of speed, wheel speed, longitudinal acceleration, wheel torque, an acceleration input value, or a gear input value of the vehicle.

7. The apparatus of claim 6, wherein the controller determines whether the vehicle is able to escape from being stuck by the swing motion based on the monitoring data received from the sensor unit of the vehicle and selectively outputs an escape impossibility alarm signal based on a result of the determining.

8. The apparatus of claim 1,
wherein the controller further stores a stability control logic configured to control driving stability of the vehicle,
wherein the controller determines a wheel slip rate of the vehicle based on monitoring data received from a sensor unit of the vehicle for each cycle of the swing motion and selectively determines whether to lock the stability control logic depending on whether at least one of a difference in wheel slip rates of a plurality of wheels, a maximum wheel slip rate of the plurality of wheels, or an average of the wheel slip rates of the plurality of wheels exceeds a reference value, and
wherein the monitoring data includes at least one of speed, wheel speed, longitudinal acceleration, wheel torque, an acceleration input value, or a gear input value of the vehicle.

9. The apparatus of claim 1,
wherein the controller determines whether the vehicle enters the stuck state while driving based on monitoring data received from a sensor unit of the vehicle and selectively controls control swing motion of the vehicle based on the swing control logic according to a result of the determining whether the vehicle enters the stuck state, and
wherein the monitoring data includes at least one of speed, wheel speed, longitudinal acceleration, wheel torque, an acceleration input value, or a gear input value of the vehicle.

10. The apparatus of claim 1,
wherein the controller determines a real-time driving direction of the controller based on monitoring data of a sensor unit of the vehicle, select one of the forward torque pattern and the reverse torque pattern according to the determined real-time driving direction, and apply the selected torque pattern to real-time driving of the controller, and
wherein the monitoring data includes at least one of speed, wheel speed, longitudinal acceleration, wheel torque, an acceleration input value, or a gear input value of the vehicle.

11. A method for controlling vehicle stuck escape, the method comprising:
storing a swing control logic configured to control swing motion of a vehicle for the vehicle to escape from a stuck state thereof, in a controller; and
controlling, by the controller, the swing motion of the vehicle according to the swing control logic,
wherein the swing control logic is configured so that a slope characteristic of one cycle of a forward torque pattern which is in a forward direction with respect to the swing motion of the vehicle and a slope characteristic of one cycle of a reverse torque pattern which is in a reverse direction with respect to the swing motion of the vehicle are different from each other.

12. The method of claim 11, wherein the swing control logic is configured so that at least one of a maximum slope, an initial slope, or an average slope of the one cycle of the reverse torque pattern is steeper than at least one of a maximum slope, an initial slope, or an average slope of the one cycle of the forward torque pattern.

13. The method of claim 12, further comprising:
determining, by the controller, a road surface condition based on monitoring data received from a sensor unit of the vehicle; and
varying the slope characteristic of at least one of the reverse torque pattern or the forward torque pattern according to the road surface condition.

14. The method of claim 13, further comprising:
determining, by the controller, a swing control characteristic based on the monitoring data of the sensor unit of the vehicle for each cycle of the swing motion,
wherein the swing control characteristic includes at least one of a swing displacement or a swing time of one cycle, and
wherein the monitoring data includes at least one of speed, wheel speed, longitudinal acceleration, wheel torque, an acceleration input value, or a gear input value of the vehicle.

15. A storage medium having recorded thereon one or more programs including instructions for executing the method of claim 11 for controlling vehicle stuck escape.

16. A vehicle comprising:
a controller including a processor and a storage medium having recorded thereon one or more programs configured to be executable by the processor,
wherein the one or more programs include instructions for executing the method of claim 11 for controlling the vehicle stuck escape.

17. A vehicle comprising:
a first motor providing torque to a front wheel of the vehicle;
a second motor providing torque to a rear wheel of the vehicle; and
a controller storing a swing control logic configured to control swing motion of the vehicle for the vehicle to escape from a stuck state thereof and controlling the first motor and the second motor according to the swing control logic,
wherein the swing control logic is configured so that a slope characteristic of one cycle of a forward torque pattern which is in a forward direction with respect to the swing motion of the vehicle and a slope characteristic of one cycle of a reverse torque pattern which is in a reverse direction with respect to the swing motion of the vehicle are different from each other.

18. The vehicle of claim 17, further comprising
a sensor unit sensing monitoring data including at least one of speed, wheel speed, longitudinal acceleration, wheel torque, an acceleration input value, or a gear input value of the vehicle,
wherein the controller determines torque directions of the first motor and the second motor based on the monitoring data and selects one of the forward torque pattern and the reverse torque pattern according to a determined real-time torque direction, and the controller controls the first motor and the second motor according to the selected torque pattern.

19. The vehicle of claim 18, wherein the swing control logic is configured so that at least one of a maximum slope, an initial slope, or an average slope of the one cycle of the reverse torque pattern is steeper than at least one of a maximum slope, an initial slope, or an average slope of the one cycle of the forward torque pattern.

20. The vehicle of claim 19,
wherein the controller determines a road surface condition based on the monitoring data and varies the slope characteristic of at least one of the reverse torque pattern or the forward torque pattern according to the road surface condition, and
wherein the monitoring data of the sensor unit includes a longitudinal acceleration of the vehicle.
